(19) United States
(12) Patent Application Publication
(10) Pub. No.: US 2013/0318773 A1
(43) Pub. Date: Dec. 5, 2013

(54) APPARATUS FOR IMMOBILISING A COMPONENT DURING A MACHINING OPERATION

(71) Applicant: Steven Moss, Derby (GB)

(72) Inventor: Steven Moss, Derby (GB)

(73) Assignee: ROLLS-ROYCE PLC, London (GB)

(21) Appl. No.: 13/983,600

(22) PCT Filed: Jan. 26, 2012
(86) PCT No.: PCT/EP2012/051193

§ 371 Date: Aug. 12, 2013

(30) Foreign Application Priority Data
Feb. 18, 2011 (GB) 1102799.2

(51) Int. Cl. B23Q 3/06

(52) U.S. Cl. CPC B23Q 3/06
USPC 29/559; 269/86; 269/74; 269/80

(57) ABSTRACT

An apparatus for immobilising a component during a machining operation is provided. The component has a securing region and an elongate body to be machined extending therefrom. The apparatus has a clamp which is configured to immobilise the component at the securing region. The clamp, in use, exerts clamping forces on the securing region. The apparatus further has a support fixture which is movable relative to the clamp to confine the elongate body at a support region thereof distal from the securing region. The support fixture is configured such that, without exertion of clamping forces on the support region by the support fixture, the confined support region is unable to move during the machining operation.

The present invention relates to an apparatus for immobilising a component during a machining operation.

Precision cast components such as blades and vanes of gas turbine engines often require finishing machining to secure final tolerances and remove casting artefacts. In order to perform such machining operations, the components have first to be properly secured and immobilised. Conventional immobilising apparatuses utilise clamps for clamping spaced regions of the component such that component is unable to move during machining.

A blade or vane usually has a convenient securing region at its base. For example, in the case of a blade, this may be dovetail or fir-tree connector or associated region. Such a relatively massive part of the component can accept substantial clamping forces without distortions being transmitted to other parts of the component.

However, when similar clamping forces are applied to e.g. the aerofoil body of a blade or vane, the forces can cause distortion of the aerofoil body by unpredictable amounts. Such distortion can reduce the accuracy of machining operations on the aerofoil body.

An aim of the present invention is, therefore, to provide an apparatus for immobilising a component during a machining operation which does not cause distortion of the component.

Accordingly, a first aspect of the present invention provides an apparatus for immobilising a component during a machining operation, the component having a securing region and an elongate body to be machined extending therefrom, wherein the apparatus has:

a clamp which is configured to immobilise the component at the securing region, the clamp, in use, exerting clamping forces on the securing region, and

a support fixture which is movable relative to the clamp to confine the elongate body at a support region thereof distal from the securing region, the support fixture being configured such that, without exertion of clamping forces on the support region by the support fixture, the confined support region is unable to move during the machining operation.

Advantageously, by appropriate configuration of the support fixture, the exertion of clamping forces on the support region can be avoided and consequent distortion of the elongate body prevented.

The apparatus may have any one or, to the extent that they are compatible, any combination of the following optional features.

The component can be an aerofoil component, the securing region being a base of the component and the elongate body being an aerofoil body extending from the base portion. For example, the component can be blade or vane of a gas turbine engine. In the case of a blade, the securing region can conveniently be a fir-tree or dovetail connector which, in use, secures the blade to a matching recess. However, the securing region can be a block from which such a connector is later machined, or it can be a sacrificial tang.

Preferably, the apparatus has no other clamps or fixtures immobilising the component during the machining operation. That is, the component can be sufficiently immobilised during machining by use of only the clamp and the support fixture.

Preferably, the support fixture is configured to substantially encircle the confined support region. In this way, all translational and rotational movement of the support region can be suppressed.

Preferably, the support fixture contacts the support region at at least three spaced positions, and more preferably at at least four spaced positions, to prevent movement of the support region during the machining operation.

Conveniently, the support fixture may be a pair of jaws which are pivotably and translatably movable relative to the clamp to confine the support region therebetween. Such jaws can be readily adjusted to accommodate components having variations in the shape of the support region.

The apparatus may further have an adjustable connector for the support fixture, the adjustable connector having a first setting in which the fixture is movable relative to the clamp to allow the fixture to be positioned such that the support region is confined by the fixture, and a second setting in which the fixture is immobilised in that position relative to the clamp. For example, the adjustable connector can include a tie bar and a yoke through which the tie bar extends, the yoke being fixed relative to the clamp, the support fixture being movably connected to a distal end of the tie bar, and the distal or a proximal end of the tie bar carrying a securing mechanism. Thus, the first setting can be provided by a loosened setting of the securing mechanism which allows the support fixture to move, and the second setting can be provided by a secured setting of the securing mechanism which pulls the tie bar through the yoke to prevent the support fixture from moving. Preferably the securing mechanism is carried by the proximal end of the tie bar so that any distortions of the tie bar and yoke caused by operating the securing mechanism can be reduced or avoided. Conveniently, the securing mechanism can be a nut which is threadingly engaged to the end of the tie bar.

A second aspect of the present invention provides the use of the apparatus according to the first aspect for immobilising a component, such as a blade or vane, during a machining operation.

A third aspect of the present invention provides a method of machining a component, such as a blade or vane, the component having a securing region and an elongate body to be machined extending therefrom, wherein the method includes:

providing the apparatus according to the first aspect,

immobilising the component at the securing region by clamping the securing region with clamp,

moving the support fixture relative to the clamp to confine the elongate body at a support region thereof distal from the securing region, and

machining the elongate body, the confined support region being unable to move during the machining operation while the support fixture exerts no clamping forces on the support region.

Embodiments of the invention will now be described by way of example with reference to the accompanying drawings in which:

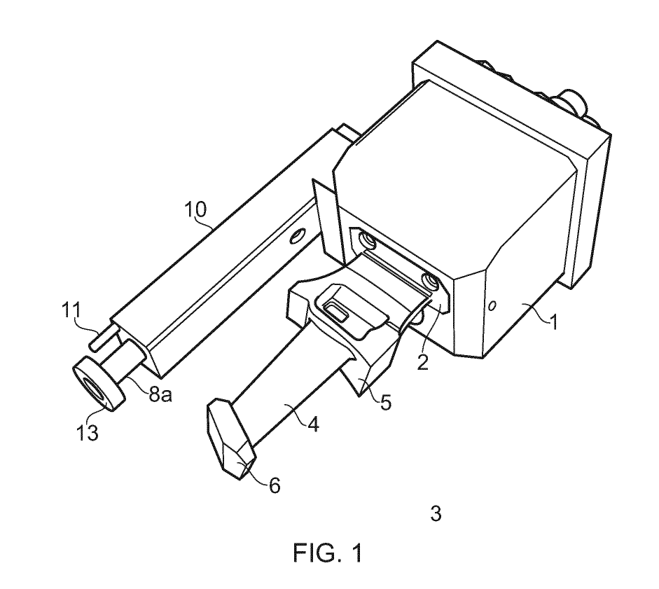

FIG. 1 shows a perspective view of an apparatus for immobilising a turbine blade, securing jaws of the apparatus being omitted for clarity;

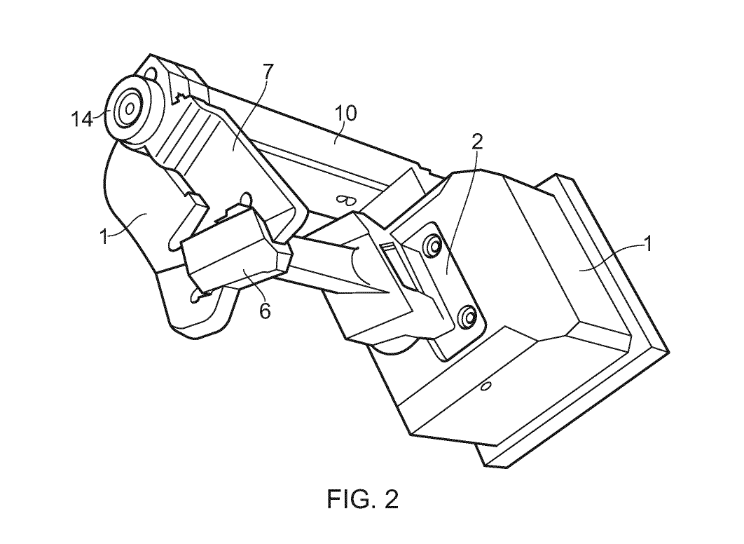

FIG. 2 shows a further perspective view of the apparatus with the securing jaws;

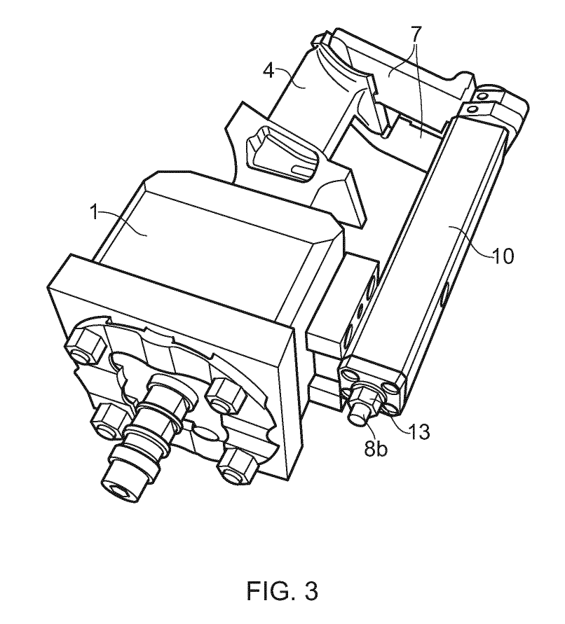

FIG. 3 shows a further perspective view of the apparatus with the securing jaws;

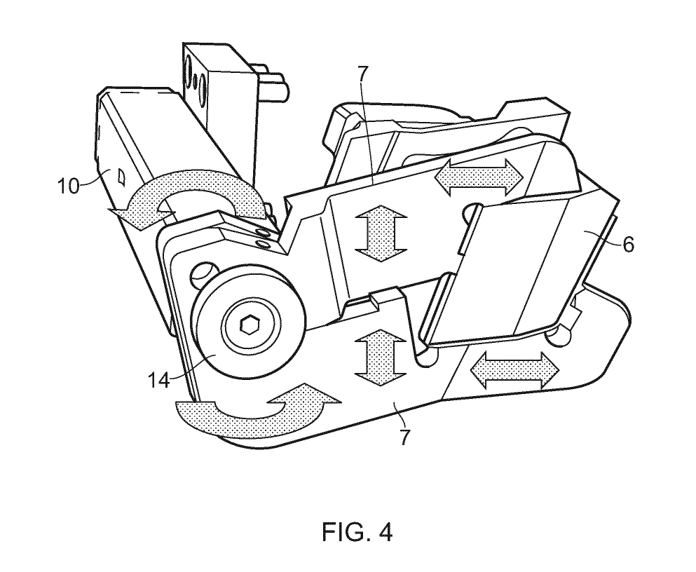

FIG. 4 shows a further perspective view of the apparatus and indicates possible movements of the securing jaws; and

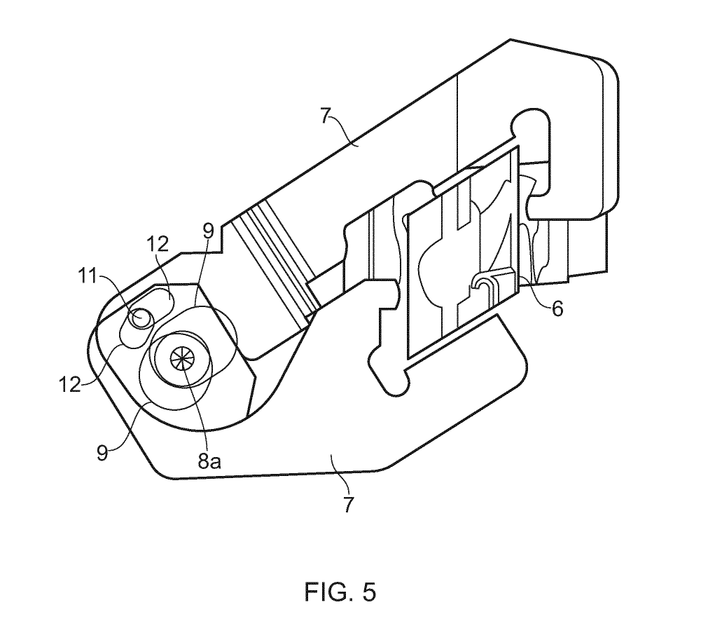

FIG. 5 shows a plan view of the securing jaws.

FIGS. 1 to 3 show perspective views of an apparatus for immobilising a turbine blade during machining of the aerofoil body of the blade. However, the apparatus can also be used for immobilising other components during machining.

The apparatus has a solid base 1 containing a clamp 2 which clamps onto a sacrificial tang extending from the fir-tree connector region of the turbine blade 3, with the aerofoil body 4 extending away from the clamp. Full access to the aerofoil body is required by a milling cutter to allow finish machining of the body and adjacent gas-washed surfaces of the platform 5 and tip shroud 6 of the blade. However, merely held by the clamp, the blade would be insufficiently supported to resist machining forces, and would be susceptible to cutter push-off and chatter. On the other hand, applying another clamp to e.g. the tip end of the aerofoil body would introduce distortions in the body and these in turn would reduce the precision of the machining operation.

Accordingly, the apparatus has a support fixture for the aerofoil body which is able to confine the body at a support region such as the shroud 6, but which does not exert clamping forces on the shroud and therefore does not distort the body. The support fixture is provided by a pair of securing jaws 7 (not shown in FIG. 1) which are pivotably and translatably movable relative to the clamp 2, as shown in FIG. 4 which is a further perspective view of the apparatus and indicates possible movements of the jaws by block arrows. More particularly, the jaws are connected, as shown in FIG. 5 which is a plan view of the jaws, to the distal end 8a of a tie bar. Oversized holes 9 in the jaws which pass over the distal end of the tie bar allow the jaws to pivot and translate. The tie bar extends through a yoke 10 which is rigidly connected to the base 1. A pin 11 at the end of the yoke passes through slots 12 in the jaws to limit the range of movements of the jaws.

A proximal end 8b of the tie bar protrudes from the yoke 10 and terminates in a thread to which is secured a tightening nut 13. With the nut loosened, the jaws can be manoeuvred into position to substantially encircle the shroud 6, the jaws being shaped to confine the shroud by making contact with the shroud on four different sides thereof (as best shown in FIG. 5). The nut is then tightened which pulls the tie bar through the yoke. An abutment member 14 at the distal end 8a of the tie bar is thereby urged into engagement with the outer jaw and clamps the jaws together against the end of the yoke. This immobilises the jaws, preventing their further movement and securing the confinement of the shroud. By positioning the nut at the proximal end of the tie bar (instead of at the distal end), any twisting or distortion of the yoke and tie bar arrangement is reduced.

Importantly, in confining the shroud 6, the jaws 7 do not exert any clamping forces. There is, therefore, no distortion of the aerofoil body 4. On the other hand, the confinement is sufficient to avoid cutter push-off and suppress chatter during machining. Further, the jaws still allow adequate access to the aerofoil body by the milling cutter.

After the machining operation, the blade 3 can be released by loosening the tightening nut 13, opening the securing jaws 7, and then loosening the clamp 2.

Although, described above in relation to milling, the apparatus can also be used for other machining operations, such as grinding, electro discharge machining, where component distortion must be avoided.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. An apparatus for immobilising a component during a machining operation, the component having a securing region and an elongate body to be machined extending therefrom, wherein the apparatus has:
a clamp which is configured to immobilise the component at the securing region, the clamp, in use, exerting clamping forces on the securing region, and
a support fixture which is movable relative to the clamp to confine the elongate body at a support region thereof distal from the securing region, the support fixture being configured such that, without exertion of clamping forces on the support region by the support fixture, the confined support region is unable to move during the machining operation.

2. An apparatus according to claim 1, wherein the component is an aerofoil component, the securing region being a base of the component and the elongate body being an aerofoil body extending from the base portion.

3. An apparatus according to claim 1 which has no other clamps or fixtures immobilising the component during the machining operation.

4. An apparatus according to claim 1, wherein the support fixture is configured to substantially encircle the confined support region.

5. An apparatus according to claim 1, wherein the support fixture contacts the support region at at least three spaced positions to prevent movement of the support region during the machining operation.

6. An apparatus according to claim 1, wherein the support fixture is a pair of jaws which are pivotably and translatably movable relative to the clamp to confine the support region therebetween.

7. An apparatus according to claim 1 further having an adjustable connector for the support fixture, the adjustable connector having a first setting in which the fixture is movable relative to the clamp to allow the fixture to be positioned such that the support region is confined by the fixture, and a second setting in which the fixture is immobilised in that position relative to the clamp.

8. An apparatus according to claim 7, wherein the adjustable connector includes a tie bar and a yoke through which the tie bar extends, the yoke being fixed relative to the clamp, the support fixture being movably connected to a distal end of the tie bar, and the distal end or a proximal end of the tie bar carrying a securing mechanism;
wherein the first setting is provided by a loosened setting of the securing mechanism which allows the support fixture to move, and the second setting is provided by a secured setting of the securing mechanism which pulls the tie bar through the yoke to prevent the support fixture from moving.

9. An apparatus according to claim 8, wherein the securing mechanism is carried by the proximal end of the tie bar.

10. Use of the apparatus according to claim 1 for immobilising a component during a machining operation.

11. A method of machining a component, the component having a securing region and an elongate body to be machined extending therefrom, wherein the method includes:
providing the apparatus according to claim 1,
immobilising the component at the securing region by clamping the securing region with clamp,
moving the support fixture relative to the clamp to confine the elongate body at a support region thereof distal from the securing region, and
machining the elongate body, the confined support region being unable to move during the machining operation while the support fixture exerts no clamping forces on the support region.
